(19) United States
(12) Patent Application Publication
(10) Pub. No.: US 2022/0331887 A1
(43) Pub. Date: Oct. 20, 2022

(54) SYSTEMS AND METHODS FOR FEEDBACK FEATURES WITHIN POWER TOOLS

(71) Applicant: Hilti Aktiengesellschaft, Schaan (LI)

(72) Inventors: Marco BALTER, Feldkirch (AT); Rainer RUDIGIER, Thüringen (AT)

(21) Appl. No.: 17/762,512

(22) PCT Filed: Sep. 23, 2020
(86) PCT No.: PCT/EP2020/076502

§ 371 Date: Mar. 22, 2022

Related U.S. Application Data
(60) Provisional application No. 62/911,442, filed on Oct. 7, 2019.

(51) Int. Cl. B23B 49/00

(52) U.S. Cl. CPC B23B 49/00; B28D 7/005

(57) ABSTRACT

Systems and methods for feedback features within power tools are provided. A method includes determining an operational parameter of a core drill based at least in part on sensor feedback. The sensor feedback is measured by one or more sensors disposed within the core drill. The method includes determining a feedback response to an operator based in part on the operational parameter and sending a command signal to a feedback output device. The method includes generating a feedback effect on an operator via the feedback output device, where the feedback effect comprises a change in a color of an external surface of the core drill.

### BACKGROUND

The present disclosure relates generally to the field of power tools, and more particularly to feedback features within power tools.

Within the construction industry, drilling systems are typically utilized to create holes or through-formations within mineral materials (e.g., concrete, brickwork, etc.). Drilling systems may include a core drill, and one or more auxiliary devices that provide support for the core drill. For example, in certain configurations, a machine stand, a feed device, a water management device, a vacuum and/or a suction device may be utilized as auxiliary devices for the core drill. In certain situations, drilling systems may include a computing device (e.g., mobile computing device) that is configured to support the core drill and the auxiliary devices.

During operation of the drilling system, each component of the system may communicate operating commands, sensor information, parameters, data, or other types of information to another component of the system. In certain situations, feedback may be provided to an operator based on this information. For example, visual or optical signals (e.g., LEDs) may be utilized to alert an operator about a drilling system operating condition. However, it may be difficult for an operator to recognize these signals in working environments filled with light, sound, and/or dirt. Accordingly, it may be beneficial to include systems and methods for embedded feedback features within various components of the drilling system to easily communicate information to an operator.

### BRIEF DESCRIPTION

Certain embodiments commensurate in scope with the originally claimed subject matter are summarized below. These embodiments are not intended to limit the scope of the claimed subject matter, but rather these embodiments are intended only to provide a brief summary of possible forms of the subject matter. Indeed, the subject matter may encompass a variety of forms that may be similar to or different from the embodiments set forth below.

In a first embodiment, systems and methods for feedback features within power tools are provided. A method includes determining an operational parameter of a core drill based at least in part on sensor feedback. The sensor feedback is measured by one or more sensors disposed within the core drill. The method includes determining a feedback response to an operator based in part on the operational parameter and sending a command signal to a feedback output device. The method includes generating a feedback effect on an operator via the feedback output device.

In certain embodiments, the feedback effect comprises a change in a color of an external surface of the core drill. In certain embodiments, the feedback effect includes projecting a virtual object on a working surface of the core drill, where the virtual object comprises a text, an image, a video, a number, or a combination thereof. In certain embodiments, the feedback effect includes projecting an image on a working surface of the core drill via one or more lasers, where the image comprises a text, an image, a video, a number, or a combination thereof. In certain embodiments, the feedback effect includes communicating a vibration, a series of vibrations, or a pattern of vibrations to the operator through the core drill and/or through a handle of the core drill. In certain embodiments, the feedback effect includes a change on a flexible surface layer of the core drill, such as a change in texture, color, temperature, friction coefficient, a tactile sensation, or a combination thereof. In certain embodiments, the feedback effect includes a surface deformation of a flexible surface layer of the core drill.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic of an embodiment of a drilling system, where the drilling system includes a core drill, one or more auxiliary devices, and a feedback output device;

FIG. 2 is a schematic of an embodiment of the drilling system of FIG. 1, where the core drill includes a feedback determination/generation module and the feedback output device; and

FIG. 3 is a method of an embodiment of the drilling system of FIG. 2, where the feedback output device generates a feedback effect for an operator.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

In certain embodiments of the present disclosure, a drilling system may include systems and methods for feedback features for communications from components of the drilling system to an operator. The drilling system may include a core drill and one or more auxiliary devices communicatively and operatively coupled to the core drill. The auxiliary devices may include one or more of a machine stand, a feed device, a water management device, a vacuum, a suction device, a mobile computing device, a computing device (e.g., back office computers, servers, manufacturing equipment, cloud services, databases, etc.), or any similar device. In certain embodiments, information, such as operating commands, operating parameters, drive signals, input/out signals, sensor information, motor control, lock-down commands, ON/OFF, current or historical data, etc., may be communicated between the components of the drilling system. For example, in certain embodiments, the core drill may generate information that is communicated to one or more auxiliary devices. In some embodiments, the auxiliary device may generate information that is communicated to the core drill and/or one or more auxiliary devices. In certain embodiments, the core drill may generate information that is communicated to cloud services (or other remote computing devices) via a mobile computing device.

In certain embodiments, additional information may need to be communicated to an operator based on the information generated and communicated between components of the drilling system. As an example, based on a certain operating parameter, an alert may be provided to an operator. However, it may be difficult for an operator to recognize visual or optical signals (e.g., LEDs) in working environments filled with light, sound, and/or dirt. Accordingly, it may be beneficial to include systems and methods for embedded feedback features within various components of the drilling system to easily communicate information to an operator.

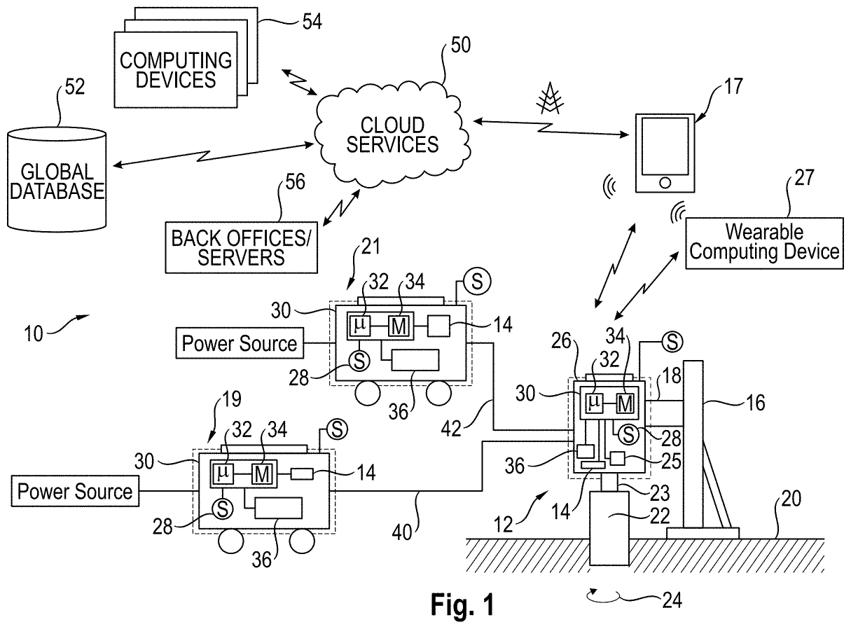

In certain embodiments, components of the drilling system may include a feedback determination/generation module. The feedback determination/generation module may be configured to determine a type of feedback (e.g., a haptic feedback response, a visual feedback response, augmented features, enchanted features or objects, ambient features, etc.) and provide a command signal to a feedback output device to implement the feedback desired. The feedback output device may be configured to output the feedback (e.g., a feedback effect in response to the command signal) to the operator. Accordingly, FIGS. 1-3 describe systems and methods for a drilling system with embedded feedback features configured to easily provide information to an operator.

Turning now to the drawings, FIG. 1 is a schematic of an embodiment of a drilling system 10, where the drilling system 10 includes a core drill 12, one or more auxiliary devices, and a feedback output device 14. The core drill 12 may be configured to cut holes or form through-formations within various materials (e.g., concrete, cement, brickwork, etc.). The drilling system 10 may include various auxiliary devices that provide operating support for the core drill 12. In the illustrated embodiment, the auxiliary devices include a machine stand 16, a feed device 18, a water management device 19, a suction device 21, and a mobile computing device 17. It should be noted that in other embodiments, various other auxiliary devices may be utilized within the drilling system 10. For example, in certain embodiments, the drilling system 10 may include a wearable computing device 27 (e.g., smartwatch) that is communicatively coupled to other components of the drilling system 10.

In certain embodiments, the drilling system 10 may include a machine stand 16 for supporting the core drill 12. The drilling system 10 may also include a feed device 18 for moving the core drill 12 along the length of the machine stand 16. The machine stand 16 may be secured to the substrate 20 with one or more fastening means (e.g., screws, bracing, etc.). In this manner, the core drill 12 may be moved towards or away from the substrate material 20 to form holes (e.g., boreholes) within the substrate 20 (e.g., concrete, cement, brickwork, etc.). Specifically, the core drill 12 may include a drill bit 22 connected to an output shaft 23. The drill bit may be configured to engage the substrate 20 in a rotational direction 24 to create the holes. The output shaft 23 may rotate in the rotational direction 24, and may be driven by a drive unit 25 disposed within a housing 26 of the core drill 12.

In certain embodiments, the core drill 12 includes various components disposed within the housing 26. For example, the core drill 12 may include control circuitry 30 communicatively coupled to a processor 32, a memory 34, one or more sensors 28, the drive unit 25, and a communications circuitry 36. The control circuitry 30 may be configured to control operations of the core drill 12, such as operating parameters of the drive unit and motor 25 and the output shaft 23. The control circuitry 30 may be configured to regulate other parameters of the core drill 12, such as a speed, torque, contact force, modes of operation (e.g., economy mode, high-performance mode, etc.), type of drill bit 22 selected, ON/OFF commands, a status of the drill, and other operating parameters. The one or more sensors 28 may be communicatively and operatively coupled to the control circuitry 30, and may be configured to provide feedback (e.g., measured value) on the various operating parameters. For example, the sensors 28 may be safety sensors, position and/or orientation sensors, touch sensors, pressure sensors, accelerometers, temperature sensors, proximity and displacement sensors, image sensors, level sensors, gyroscopes, force sensors, speed sensors, etc. Each of the one or more sensors 28 may be configured to provide a measure value related to the core drill 12 (e.g., a speed, a contact force, a position and/or orientation, and so forth), to the control circuitry 30. In certain embodiments, the control circuitry 30 may operate in a feedback loop based in part on the information provided by the sensors 28.

In certain embodiments, the control circuitry 30 may be communicatively coupled to the processor 32 and the memory 34. The processor 32 may be configured to execute instructions stored on the memory 34 to carry out the functions of the core drill 12. The memory 34 may be configured to store instructions that are loadable and executable on the processor 32. In certain embodiments, the memory 34 may be volatile (such as a random access memory (RAM)) and/or non-volatile (such as read-only memory (ROM), flash memory, etc.). The control circuitry 30 may also include additional removable storage and/or non-removable storage including, but not limited to, magnetic storage, SD card, flash storage, USB storage, optical disks, and/or tape storage. In some implementations, the memory 34 may include multiple different types of memory, such as static random access memory (SRAM), dynamic random access memory (DRAM), or ROM.

In certain embodiments, the memory 34 may be configured to store information related to the core drill 12 and/or other components of the drilling system 10. For example, the memory 24 may store unique identification information related to the core drill 12, unique identification information related to the manufacturer, owner, and/or previous owners of the core drill 12, historical information related to the operation of the core drill 12 (e.g., runtime), error codes or alerts triggered, historical information related to the repair and/or theft, sensor information gathered from one or more sensors 28, information related or received from the auxiliary devices, drive signals provided by the control circuitry 30 and/or input signals provided by operator, the general state of the health of the core drill 12, and/or other types of information. In particular, the memory 24 may be configured to store any type of information that is useful to operate the core drill 12 and other components of the drilling system 10.

The control circuitry 30 may be communicatively coupled to the communications circuitry 36 disposed within the housing 26. In certain embodiments, the control circuitry 30 may be configured to generate data packages of information that are wirelessly transmitted by the communications circuitry 36 to an auxiliary device, a remote computing device (e.g., server/mobile phone) and/or a mobile computing device (e.g., smartphone). In certain embodiments, the communications circuitry 36 may be enabled to transmit information via one or more different wireless modes of operation, such as, but not limited to, Bluetooth, Near Field Communication (NFC), Wifi, ZigBee, LoRa, LoRaWAN, Sigfox, Cellular, etc.

In certain embodiments, the control circuitry 30 may be configured to determine and generate a feedback response that is communicated to the operator. For example, as noted above, the control circuitry 30 may be configured to regulate operations of the core drill 12 and may be configured to regulate various operational parameters of the core drill 12. In response to the measured values provided by the one or more sensors 28, the control circuitry 30 may be configured to operate in a feedback loop. In certain embodiments, the control circuitry 30 may need to communicate information (e.g., alerts, warnings, operational guidance, status updates, levels or quantities of consumables, power remaining, etc.) to the operator based on these operational parameters. Accordingly, the control circuitry 30 may be configured to generate and determine an appropriate feedback response to easily communicate information to the operator. In certain embodiments, the control circuitry 30 may be configured to send a command signal to the feedback output device 14, which may be configured to output the feedback to the operator.

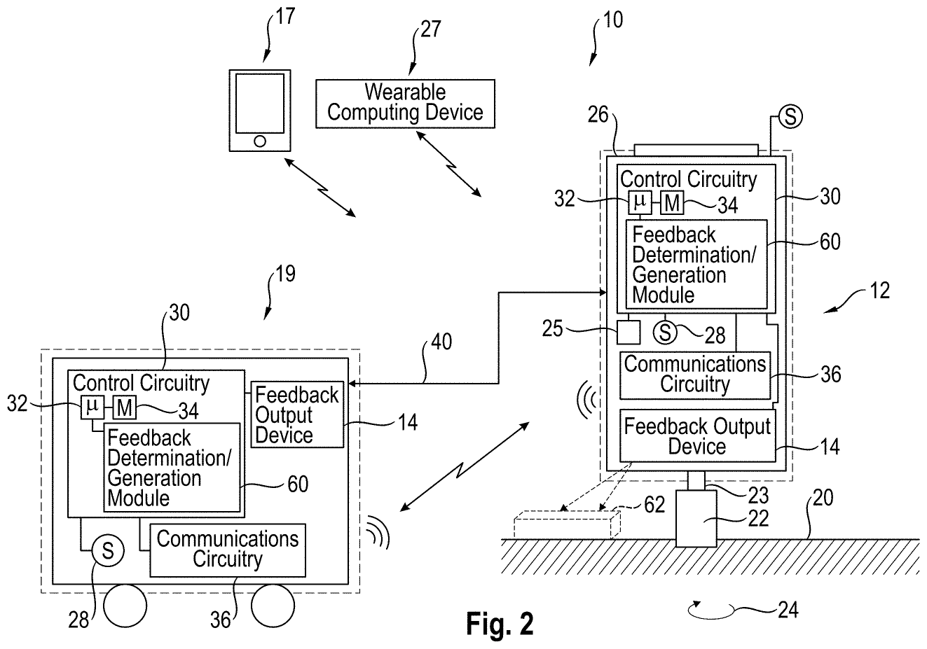

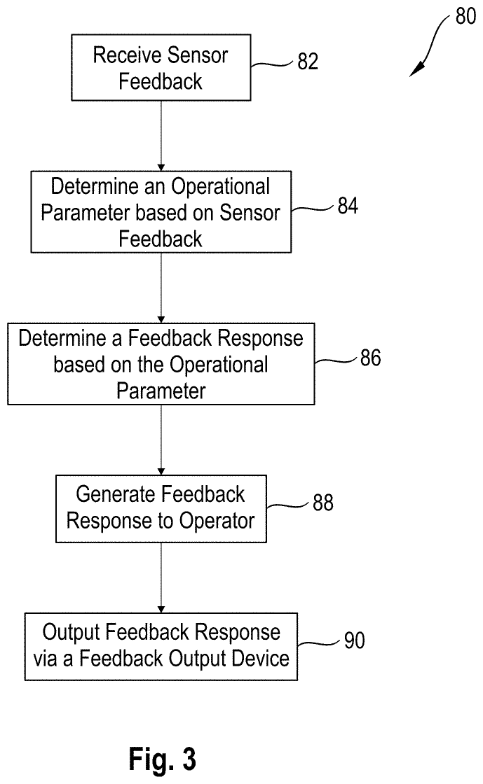

In certain embodiments, the feedback output device 14 may be configured to provide a feedback effect on the operator, as further described with respect to FIG. 3. In certain embodiments, the feedback output device 14 may be internal and/or external to the control circuitry 30, and may be communicatively coupled to the control circuitry 30 via a wired (e.g., Ethernet, USB, etc.) or a wireless connection (e.g., Bluetooth, radio, Nearfield, etc.). For example, the feedback output device 14 may be associated with (e.g., coupled to) the wearable computing device 27 (e.g., smartwatch) and may receive feedback command signals from the processor 32. In certain embodiments, one or more feedback output devices 14 may be utilized within the core drill 12. In other embodiments, the feedback output devices 14 of multiple components within the drilling system 10 may be utilized in series or in conjunction within one another. These and other features of the feedback output device 14 are described in further detail with respect to FIGS. 2-3.

As noted above, the drilling system 10 may include one or more auxiliary devices, including the water management device 19, the suction device 21, and the mobile computing device 17. In certain embodiments, the water management device 19 may be operatively connected to the core drill 12 with a hose 40, and may be configured to supply the core drill 12 with a source of water. The water may be guided to the drilling area with the hose 40. In certain embodiments, the water management device 19 may include a dust or a water suction, and a water pump. In particular, the water management device 19 may include its own control circuitry 30, the processor 32, the memory 34, one or more sensors 28, and the communications circuitry 36. In certain embodiments, the water management device 19 may include the feedback output device 14. The one or more sensors 28 of the water management device 19 may measure a water volume, a water flow, an activation or deactivation of the water management device 19, an operation of the water pump, and other operating parameters. The sensors 28 of the water management device 19 may be configured to provide the measured information to the control circuitry 30 of the water management device 19. The control circuitry 30 may generate data packages of this information to wirelessly share (via the communications circuitry 36) to the core drill 12 and/or one or more other components of the drilling system 10.

In certain embodiments, the drilling system 10 includes the suction device 21, which may be operatively connected to the core drill 12 with a second hose 42. During the drilling process, waste products may be generated in and around the drilling area. The suction device 21 may be configured to remove the waste products from the drilling area, via the second hose 42, so that the drilling process is not hindered by accumulating waste products. In particular, the suction device 21 may include its own control circuitry 30, the processor 32, the memory 34, one or more sensors 28, and the communications circuitry 36. In certain embodiments, the suction device 21 may include the feedback output device 14. The one or more sensors 28 of the suction device 21 may measure a pressure of suction, a force, an activation or deactivation of the suction device 21, a capacity of waste product storage within the suction device 21, and other operating parameters. The sensors 28 of the suction device 21 may be configured to provide the measured information to the control circuitry 30 of the suction device 21. The control circuitry 30 may generate data packages of this information to wirelessly share (via the communications circuitry 36) to the core drill 12 and/or one or more other components of the drilling system 10.

In certain embodiments, the communications circuitry 36, may be configured to wirelessly transmit information from the core drill 12, the water management device 19 and/or the suction device 21 to an external computing device, such as a mobile computing device 17, a tablet, a desktop computer, or any other processor enabled device. One or more different modes of operation may be utilized, such as, but not limited to, Bluetooth, Near Field Communication (NFC), Wifi, ZigBee, LoRa, LoRaWAN, Sigfox, Cellular, etc. The mobile computing device 17 may include a transceiver that is configured to communicate information received to a cloud-based computing system 50 via WiFi (e.g., Institute of Electrical and Electronics Engineers [IEEE] 802.11X, cellular conduits (e.g., high speed package access [HSPA], HSPA+, long term evolution [LTE], WiMax), near field communications (NFC), Bluetooth, personal area networks (PANs), and the like. The cloud-based computing device 50 may be a service provider providing cloud analytics, cloud-based collaboration and workflow systems, distributed computing systems, expert systems and/or knowledge-based systems. In certain embodiments, the cloud-based computing device 50 may be a data repository that is coupled to an internal or external global database 52.

Further, in certain embodiments, the global database 52 may allow computing devices 54 to retrieve information stored within for additional processing or analysis. Indeed, the cloud-based computing device may be accessed by a plurality of systems (computing devices 54 and/or computing devices from back offices/servers 56) from any geographic location, including geographic locations remote from the physical locations of the systems. Accordingly, the cloud-based computing system 50 may enable advanced collaboration methods between parties in multiple geographic areas, provide multi-party workflows, data gathering, and data analysis, which may increase the wireless capabilities of connectivity and communications of the drilling system 10.

FIG. 2 is a schematic of an embodiment of the drilling system 10 of FIG. 1, where the core drill 12 includes a feedback determination/generation module 60 and the feedback output device 14. In certain embodiments, the water management system 19 and the suction device 21 (shown in FIG. 1) may include the feedback determination/generation module 60 and the feedback output device 14, such that all the modules 60 and the feedback output devices 14 may be used in conjunction and/or in series. As noted above, in certain embodiments, the control circuitry 30 may be configured to determine and generate a feedback response that is communicated to the operator in a manner that is intuitive to understand. For example, the drilling system may need to communicate information (e.g., alerts, warnings, operational guidance, status updates, levels or quantities of consumables, power remaining, etc.) to the operator based on predicted or current operating parameters. Such information may be necessary for an operator to safety operate the drilling system 10. In particular, it may be beneficial to provide a feedback effect for the operator (e.g., a haptic feedback response, a visual feedback response, augmented features, enchanted features or objects, ambient features, etc.) so that the operator may easily understand the information in working environments.

In certain embodiments, the feedback output device 14 may be configured to provide a vibration (or a series or a pattern of vibrations) to the operator through the core drill 12. In certain embodiments, the vibration may occur at a portion of the core drill (e.g., handle). The feedback output device 12 may be a piezoelectric actuator, an electric motor, an electro-magnetic actuator, an eccentric rotating mass motor (ERM), a linear resonant actuator (LRA), or any device known in the art to provide a vibration response through a mechanical tool. In certain embodiments, a force feedback may be provided to the operator by changing an angle of operation for the core drill 12. For example, the core drill 12 may respond independently of the movement of the operator, and may change an operational parameter (e.g., force, speed, direction, rotation, etc.) to communicate a series of information to the operator.

In certain embodiments, the feedback output device 14 may be configured to provide a change in surface color or color intensity, a color gradient, a change in surface texture, a change in temperature, an electro-tactile effect, a surface deformation, and/or a tactile sensation. For example, in certain embodiments, the feedback output device 14 may include a flexible surface layer 60 disposed about the housing 26 of the core drill 12. The flexible surface layer 60 may be configured to alter or mechanically deform a portion of its surface (e.g., lower, raise, create bumps, etc.) to provide information to an operator. In certain embodiments, the flexible surface layer 60 may change in friction, to simulate a change in texture, vibration or other tactile sensations.

In certain embodiments, a color of a color intensity of a surface of the housing 12 may change dynamically. As an example, to alert an operator, the color of the core drill 12 may change to red to signal a warning condition. As a further example, a series or patterns of colors may be utilized and may be pre-designated for different operating conditions and/or different types of warnings/alerts/information. In certain embodiments, the feedback output device 14 may be configured to provide an electrical current (or any electrical trigger) to the surface (e.g., external surface) of the core drill 12. For example, in certain embodiments, the feedback output device 14 may be configured to provide an electrical charge, or any other electrical effect, to the surface of the core drill 12. Upon receiving the electrical current, the surface of the core drill 12 may be configured to change color (e.g., color, color gradient or color intensity) to communicate an operational parameter or a change in an operational parameter to the operator.

In certain embodiments, the feedback output device 14 may be configured to remotely project information onto a working surface (e.g., substrate 20). For example, the feedback output device 14 may be configured to display a virtual object 62 within an augmented reality environment. The virtual object 62 may include text, numbers, warning, alerts, or any other type of information that needs to be communicated to the operator. In certain embodiments, the virtual object 62 may be a manual or instructions on how to operate the core drill 12. In certain embodiments, the virtual object 62 may be a series of videos or pictures that provide instructional guidance on how to operate the drilling system 10. In certain embodiments, the feedback output device 14 includes a series of lasers that project the virtual object 62 onto the working surface (e.g., substrate 20). The lasers may display information related to the operational parameters and/or may provide operational guidance for using the drilling system 10.

FIG. 3 is a method 80 of an embodiment of the drilling system 10 of FIG. 2, where the feedback output device 14 generates a feedback effect for an operator. The illustrated embodiment and the described features are with respect to the core drill 12. However, it should be noted that these embodiments may be applicable to other auxiliary devices of the drilling system 10 (e.g., water management device 19 and/or the suction device 21). The method 80 includes receiving sensor feedback from one or more sensors 28 of the core drill 12 (block 82). In certain embodiments, based on the sensor feedback received, the control circuitry 30 may be configured to determine an operational parameter associated with current or future operations of the core drill 12 (block 84). In certain embodiments, based on the operational parameters, the control circuitry 30 may be configured to determine whether a feedback response is appropriate (block 86). For example, a feedback response to communicate information to the operator may be appropriate when the operator would benefit from having such information. In certain embodiments, the information may include alerts, warnings, operational guidance, manual, software updates, status updates, levels or quantities of consumables, power remaining, etc. In certain embodiments, the information may include other external pieces of information (e.g., not based on operational parameters), such as high temperatures, high pressures, end of a working shift, etc.

In certain embodiments, the method 80 includes generating the feedback response to the operator by sending a command signal from the control circuitry 30 (e.g., the feedback determination/generation module 60) to the feedback output device (block 88). Further, in certain embodiments, the method 80 includes outputting the feedback response via a feedback output device 90 (block 90).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A method, comprising:
determining an operational parameter of a core drill based at least on sensor feedback, wherein the sensor feedback is measured by one or more sensors disposed within the core drill;
determining a feedback response to an operator based in part on the operational parameter;
sending a command signal to a feedback output device; and
generating a feedback effect on an operator via the feedback output device.

2. The method of claim 1, wherein the feedback effect comprises a change in a color of an external surface of the core drill.

3. The method of claim 2, wherein the external surface of the core drill comprises a reactant configured to change color upon receiving an electrical effect, and wherein the feedback output device is configured to provide the electrical effect to the external surface of the core drill.

4. The method of claim 3, wherein the electrical effect is an electrical charge, an electrical current, an electrical trigger, or a combination thereof.

5. The method of claim 1, wherein the feedback effect comprises projecting a virtual object on a working surface of the core drill, and wherein the virtual object comprises a text, an image, a video, a number, or a combination thereof.

6. The method of claim 1, wherein the feedback effect comprises projecting an image on a working surface of the core drill via one or more lasers, and wherein the image comprises a text, an image, a video, a number, or a combination thereof.

7. The method of claim 1, wherein the feedback effect comprises communicating a vibration, a series of vibrations, or a pattern of vibrations to the operator through the core drill.

8. The method of claim 7, comprising communicating the vibration, the series of vibrations, or a pattern of vibrations through a handle of the core drill.

9. The method of claim 7, comprising communicating the vibration, the series of vibrations, or a pattern of vibrations through a stand of the core drill.

10. The method of claim 1, wherein the feedback effect comprises a change on a flexible surface layer of the core drill, wherein the change comprises a change in texture, color, temperature, friction coefficient, a tactile sensation, or a combination thereof.

11. The method of claim 1, wherein the feedback effect comprises a surface deformation of a flexible surface layer of the core drill.

12. The method of claim 1, further comprising an auxiliary device for the core drill, wherein the auxiliary device is a water management device.

13. The method of claim 1, further comprising an auxiliary device for the core drill, wherein the auxiliary device is a suction device.
